(19) United States
(12) Patent Application Publication
(10) Pub. No.: US 2025/0211494 A1
(43) Pub. Date: Jun. 26, 2025

(54) COMMUNICATION LINK DISRUPTION PREDICTION REPORTING AND MITIGATION

(71) Applicant: Qualcomm Incorporated, San Diego, CA (US)

(72) Inventors: Aviv REGEV, Tel Aviv (IL); Ronen SHAKED, Kfar Saba (IL); Shay LANDIS, Hod Hasharon (IL)

(21) Appl. No.: 18/391,930

(22) Filed: Dec. 21, 2023

(51) Int. Cl. H04L 41/147; H04W 24/02

(52) U.S. Cl. CPC H04L 41/147; H04W 24/02

(57) ABSTRACT

Certain aspects of the present disclosure provide techniques for reporting an upcoming disruption to a communication link. An example method for wireless communications by an apparatus includes sending a report that indicates a prediction of an upcoming disruption to one or more communication links; obtaining a response to the report, wherein the response indicates to communicate via at least one communication link; and communicating with a network entity via the at least one communication link in accordance with the response.

### INTRODUCTION

### Field of the Disclosure

Aspects of the present disclosure relate to wireless communications, and more particularly, to techniques for reporting an upcoming disruption to a communication link.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes sending a report that indicates a prediction of an upcoming disruption to one or more communication links; obtaining a response to the report, wherein the response indicates to communicate via at least one communication link; and communicating with a network entity via the at least one communication link in accordance with the response.

Another aspect provides a method for wireless communications by an apparatus. The method includes obtaining a report indicating a prediction of an upcoming disruption to one or more communication links; sending a response to the report, wherein the response indicates to communicate via at least one communication link; and communicating with a user equipment via the at least one communication link in accordance with the response.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 illustrates an example wireless communications systems where an upcoming disruption is identified at a UE and reported to a network entity.

FIG. 6 depicts a process flow for communications in a system between a network entity and a UE involved in reporting an upcoming communication link disruption.

FIG. 7 depicts a method for wireless communications.

FIG. 8 depicts another method for wireless communications.

FIG. 9 depicts aspects of an example communications device.

FIG. 10 depicts aspects of another example communications device.

### DETAILED DESCRIPTION

Aspects of the present disclosure provide apparatuses, methods, processing systems, and computer-readable mediums for mitigating a predicted disruption to a communication link.

In certain wireless communication systems, closed-loop feedback associated with a communication channel may be used to dynamically adapt communication link parameters (e.g., modulation and coding scheme (MCS), beamforming, multiple-input and multiple-output (MIMO) layers, etc.) in response to time varying channel conditions, for example, due to changes with respect to user equipment (UE) mobility, weather conditions, scattering, fading, interference, noise, etc. A UE may report channel state feedback (CSF) to a network entity (e.g., a base station), which may adjust certain communication parameters in response to the feedback from the UE. These operations may be referred to as link adaptation including, for example, adaptive modulation and coding where an MCS is adapted to certain channel conditions.

As an example, a UE may measure a reference signal and estimate the channel state based on measurements of that reference signal. The UE may report an estimated channel state to the network entity in the form of CSF. In certain aspects, the CSF may indicate conditions associated with the radio environment including channel properties of a communication link between the network entity and the UE. The CSF may indicate the effect of, for example, scattering, fading, and path loss of a signal propagating across the communication link. In some cases, the CSF may indicate the UE's preferred precoding for MIMO and/or beamformed communications, for example, in the form of precoding feedback. As an example, a CSF report may include a channel quality indicator (CQI), precoding matrix indicator (PMI), a layer indicator (LI), a rank indicator (RI), a reference signal received power (RSRP), a signal-to-interference plus noise ratio (SINR), etc. In certain cases, the CSF may indicate the channel properties associated with candidate communication links, for example, corresponding to beams. Note that other information may likewise be included in a CSF report.

Technical problems for wireless communications include, for example, unexpected physical obstructions that intersect a communication link between a UE and a network entity. In some cases, a physical obstruction may be mobile (e.g., a vehicle) and temporarily intersect the communication link. In certain cases, a UE may be mobile, for example, as a portable communications device or integrated with a vehicle. As the UE is moving, a physical obstruction (e.g., vehicle, a building, wall, tree, etc.) may temporarily intersect the communication link. The physical obstruction may affect the power of the signals communicated between the UE and network entity. For example, some of the signals may be diffracted or reflected as the signals encounter the obstruction along the communication link, and thus, the diffraction and/or reflection may cause a reduction in received signal power and/or multi-path interference at the receiving entity. Some of the signals may travel through the obstruction resulting in increased penetration losses that reduce the received signal power at the receiving entity. Thus, while the obstruction is intersecting with the communication link, the performance of the communication link can severely degrade, and in some cases, the communication link can even fail—especially for high frequency bands, such as millimeter waves or sub-terahertz waves, which may use narrow beams and are more susceptible to penetration losses due to physical obstructions. Moreover, the closed-loop feedback described above may lack information associated with a physical obstruction.

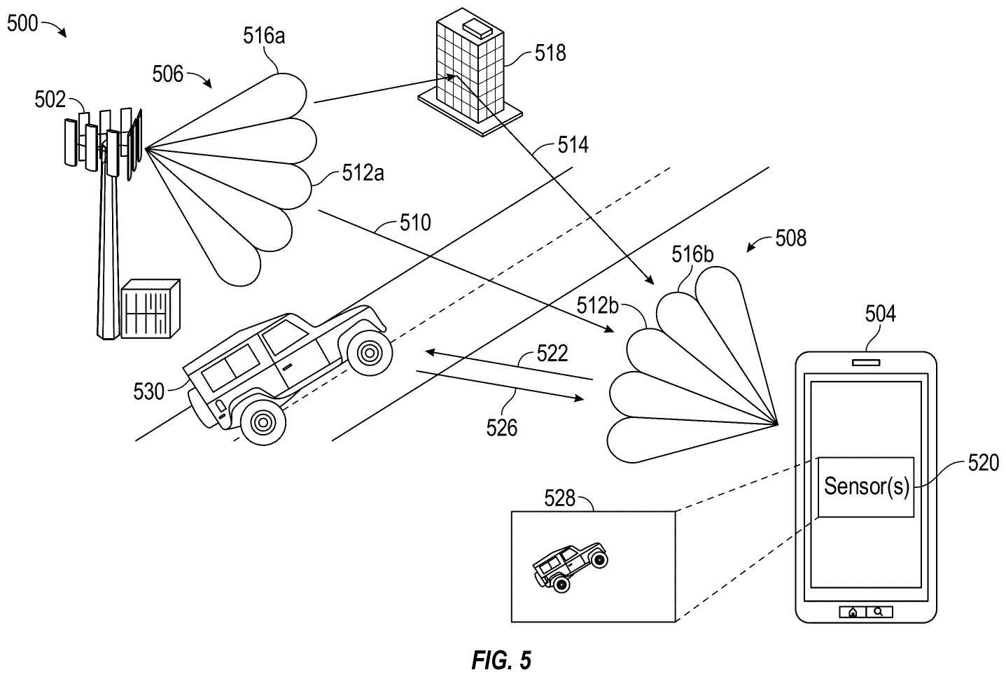

Aspects described herein overcome the aforementioned technical problem(s) by providing mitigation of an upcoming disruption to a communication link. As a UE may be equipped with one or more sensors that can perceive a physical environment in which the UE is located, the UE may monitor for any upcoming disruptions to a communication link, such as mobile obstructions. As an example, the UE may perform radar scans and monitor for any reflections that indicate when an obstruction is expected to disrupt a communication link. Note that any suitable sensing may be used in addition to or instead of radar to monitor for and/or identify an upcoming disruption as further described herein with respect to FIG. 5. If the UE identifies an upcoming (or an existing) disruption, the UE may send, to a network entity, a report indicating a prediction of an upcoming disruption to a communication link. The report may provide an indication of physical conditions of the environment surrounding the UE, for example, in terms of a physical obstruction that can block or disrupt a communication link. The network entity may perform one or more actions in response to the report. In some cases, the network entity may send, to the UE, an indication to switch to a different communication link, for example, for the expected duration of the disruption. In certain cases, the network entity may send, to the UE, an indication to temporarily refrain from communicating via the communication link, which is expected to be disrupted. In some cases, the network entity may send, to the UE, an indication to adjust parameter(s) associated with the communication link expected to be disrupted, such as reducing the MCS to compensate for any increase in path losses.

The techniques for communication link disruption mitigation described herein may provide various beneficial effects and/or advantages, including in the field of wireless communications. Forecasting potential disruptions may allow a network entity to perform one or more operations that mitigate or avoid certain effects of the disruption, such as degraded performance or communication link failure. The techniques for communication link disruption mitigation may enable communications during a disruption that could cause a beam failure or radio link failure associated with a communication link between a UE and a network entity. The improved wireless communication performance may be attributable to the report allowing a network entity to respond proactively to a potential disruption, such as indicating to a UE to communicate via an alternative communication link during the disruption and/or adjusting communication parameters that enable adequate communications during the disruption. In some cases, the techniques for communication link disruption mitigation may enable the UE to avoid or refrain from performing certain recovery operations, such as beam failure recovery and/or cell reselection, which could be triggered by the disruption and use time-frequency resources. For example, in response to an indication to refrain from communications via a communication link expected to be disrupted, the UE may refrain from performing any recovery operations, which consume channel capacity, processing resources, and can cause latency in other communications between the network entity and the UE (and/or other UE(s)). Thus, the techniques for communication link disruption mitigation may enable power savings at the UE, efficient use of channel capacity, and/or communications during a disruption.

The term “beam” may be used in the present disclosure in various contexts. Beam may be used to mean a set of gains and/or phases (e.g., precoding weights or co-phasing weights) applied to antenna elements in (or associated with) a wireless communication device for transmission or reception. The term “beam” may also refer to an antenna or radiation pattern of a signal transmitted while applying the gains and/or phases to the antenna elements. Other references to beam may include one or more properties or parameters associated with the antenna (or radiation) pattern, such as an angle of arrival (AoA), an angle of departure (AoD), a gain, a phase, a directivity, a beam width, a beam direction (with respect to a plane of reference) in terms of azimuth and/or elevation, a peak-to-side-lobe ratio, and/or an antenna (or precoding) port associated with the antenna (radiation) pattern. The term “beam” may also refer to an associated number and/or configuration of antenna elements (e.g., a uniform linear array, a uniform rectangular array, or other uniform array).

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

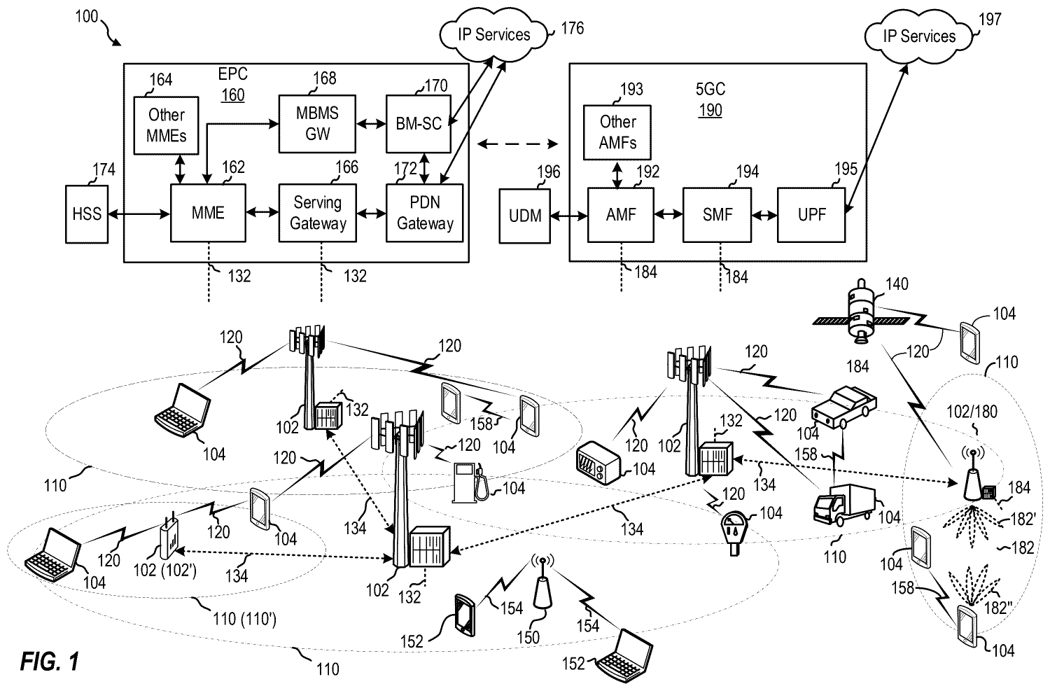

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

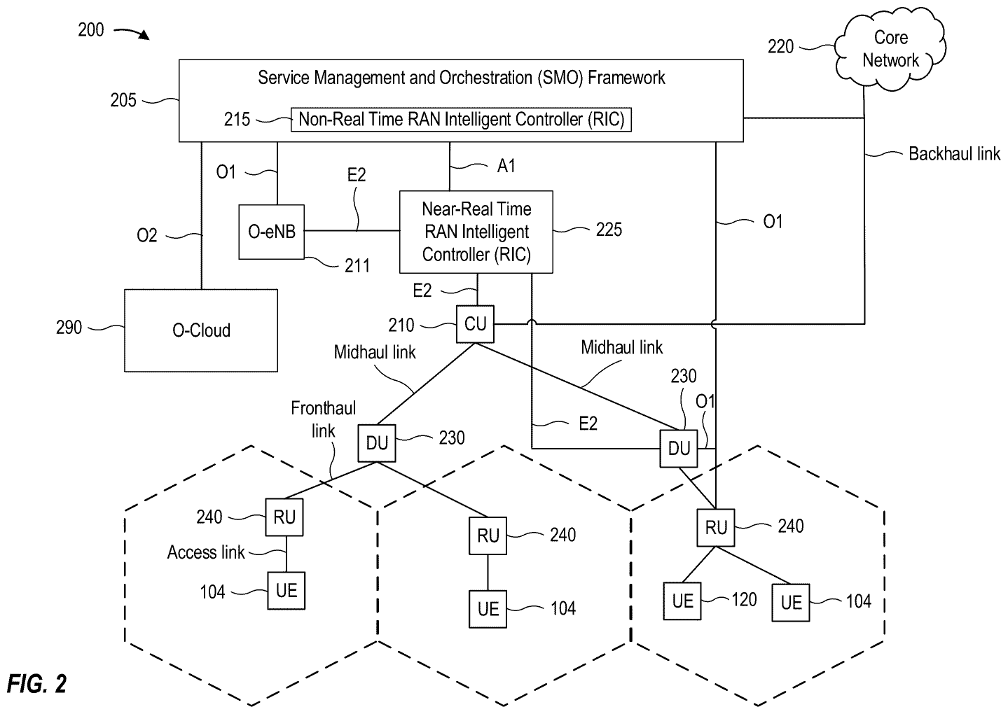

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

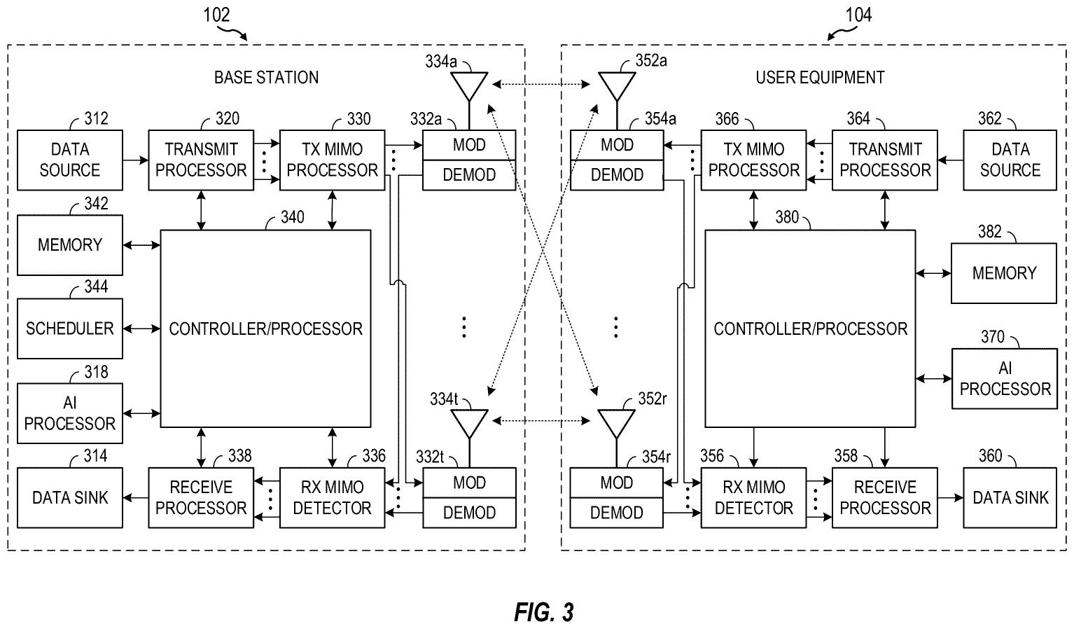

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

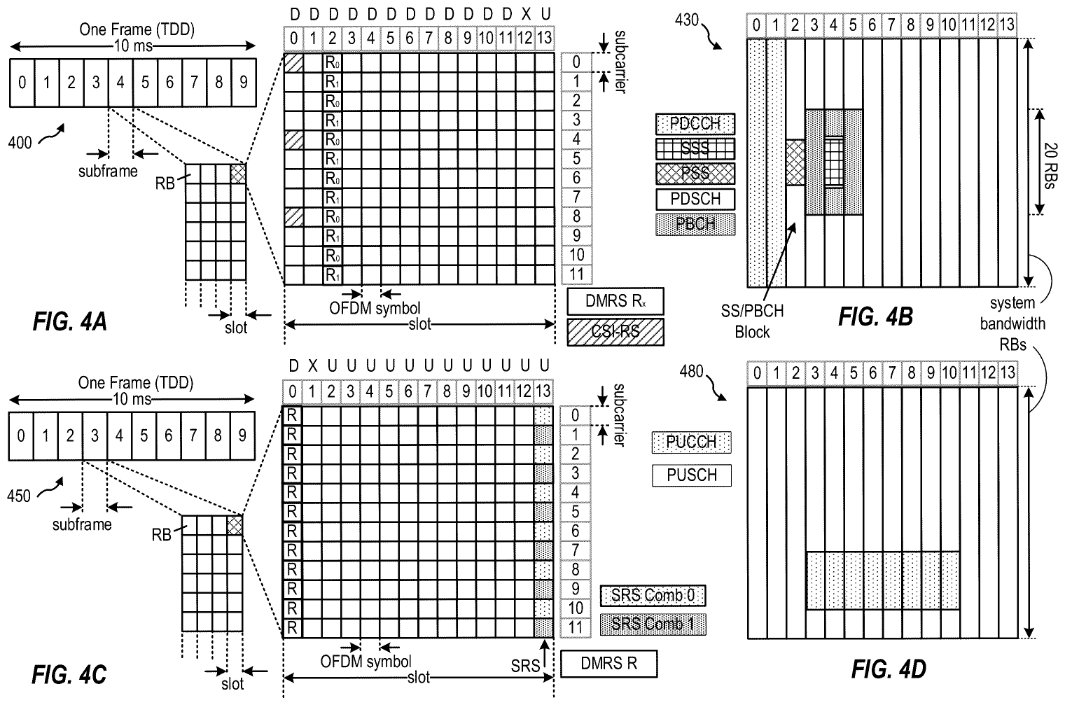

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Mitigation of a Predicted Communication Link Disruption

Aspects of the present disclosure provide techniques for mitigation of a predicted (e.g., upcoming) disruption to a communication link, such as a wireless communication link between a UE and a network entity and/or between multiple UEs.

FIG. 5 illustrates an example wireless communications systems 500 where a disruption is identified or predicted at a UE 504 and reported to a network entity 502. The wireless communications system 500 includes a network entity 502 and a UE 504. The network entity 502 communicates via a first set of beams 506; and likewise, the UE 504 communicates via a second set of beams 508.

In this example, the UE 504 is communicating with the network entity 502 via a first communication link 510a, which may be formed via a transmit-receive (Tx-Rx) beam pair, for example, including a Tx beam 512a formed at the network entity 502 and a Rx beam 512b formed at the UE 504. A second communication link 514 may be available for communications between the UE 504 and the network entity 502. The second communication link 514 may be formed via a Tx beam 516a at the network entity 502 and a Rx beam 516b at the UE 504. As an example, the second communication link 514 may be formed through a non-line-of-sight communication path (e.g., a multi-path), for example, using a building 518 to reflect RF signals to the UE 504. Various communication links (e.g., line-of-sight and/or non-line-of-sight) with corresponding Tx-Rx beam pairings may also be available for communications between the UE 504 and the network entity 502.

In some cases, the UE 504 may report channel properties associated with certain Tx beams at the network entity 502. For example, the UE 504 may measure the channel properties of received reference signals that correspond to the first set of beams 506, and the network entity 502 may schedule communications that use a particular communication link (e.g., the first communication link 510) in response to the reported channel properties.

In order to provide awareness of potential disruptions, the UE 504 monitors for any upcoming disruptions to the first communication link 510 between the UE 504 and the network entity 502, for example, using one or more sensors 520 (hereinafter “the sensor 520”). A potential disruption may include a physical obstruction that can reflect, absorb, and/or diffract RF signals and/or that can affect (e.g., increase) a penetration loss (including foliage losses and/or atmospheric losses) associated with RF signals communicated between the UE 504 and the network entity 502. In some cases, a disruption may temporarily disrupt or affect a communication link, which may be line-of-sight or non-line-of-sight. As examples, a potential disruption may be or include a vehicle, a building, a tree, a pole, a bridge, etc. In some cases, a potential disruption may be or include precipitation or moisture including, for example, fog, rain, snow, sleet, etc. In certain aspects, the sensor 520 may be configured to detect an object within a communication range of the UE 504. The sensor 520 may be or include one or more of: an RF sensor (e.g., an RF transceiver and/or radar sensor), an optical sensor (e.g., an infrared sensor and/or lidar sensor), an acoustic sensor (e.g., a sonar sensor), a camera, etc. As an example, the sensor 520 may be or include frequency modulated continuous wave (FMCW) radar sensor.

In certain aspects, the UE 504 may perform active scanning of the environment around the UE 504. As an example, the UE 504 may send one or more signals 522 (e.g., an RF signal, light pulse, sound pulse, etc. via the sensor 520) with one or more orientations (e.g., azimuth and/or elevation) that scan the environment around the UE 504. In some cases, the signal 522 may be oriented towards a space that is at least in part non-overlapping with the first communication link 510. Using the sensor 520, the UE 504 may monitor for any reflections 526 of the signal 522, for example, reflected off an object 530. In this example, the object 530 is a vehicle traveling along a path that will intersect the first communication link 510 and cause a disruption to the first communication link 510 (e.g., reflection, diffraction, and/or penetration loss). The UE 504 may determine a trajectory and/or velocity of the object 530 based on the reflections 526 from the object 530, and the UE 504 may identify that the object 530 will likely disrupt the first communication link 510 when the object 530 intersects the first communication link 510, for example, due to reflection, diffraction, and/or penetration losses as described herein. In some cases, the object 530 may be stationary such as a wall, column, pole, building, or tree. The UE 504 may identify that the object 530 will likely intersect the first communication link 510 due to the mobility of the UE 504 (e.g., trajectory, acceleration, and/or velocity). In certain aspects, the UE 504 may record the location of where an obstruction occurred, and the UE 504 may use such information when scanning for any disruptions and/or predicting a disruption.

In certain aspects, the UE 504 may perform passive scanning of the environment around the UE 504. For example, the UE 504 may use the sensor 520 to listen for any noise (e.g., RF emissions, light emissions, acoustic emissions, etc.) output from an object 530. The UE 504 may listen for any noise in one or more orientations (e.g., azimuth and/or elevation) that scan the environment around the UE 504. As an example, the reflections 526 may be representative of any noise output from the object 530.

In certain aspects, the UE 504 may process the reflections 526 (or noise) to reconstruct an image 528 of the environment surrounding the UE 504. The UE 504 may process the image 528 to identify any objects (e.g., the object 530) that could disrupt the first communication link 510, for example, via computer vision processing. In some cases, the sensor 520 may be or include one or more cameras that capture the image 528 of the environment surrounding the UE 504. For example, the sensor 520 may be or include a stereo camera that is configured to capture stereo images.

The UE 504 may notify the network entity 502 of the upcoming disruption to the first communication link 510. For example, the UE 504 may send, to the network entity 502, a notification or report associated with the disruption. Such a notification or report may include an indication of when the disruption is expected to start; an indication of when the disruption is expected to end; and/or an indication of which communication link is expected to be disrupted. In certain aspects, the indication of which communication link is expected to be disrupted may be or include a beam identifier associated with a communication beam (e.g., a Tx and/or Rx beam) expected to be disrupted, a reference signal identifier associated with communication beam expected to be disrupted, a transmission configuration indication (TCI) state associated with Tx and/or Rx beam expected to be disrupted, and/or a field of view or pose representative of a space expected to be disrupted. In certain aspects, the notification of the disruption may include an indication of a location of where the disruption is expected to occur and/or an indication of where the UE 504 is located. Such location information associated with the disruption may allow the network entity 502 to proactively modify or configure communications with other UEs (not shown) that could encounter the disruption.

In response to the notification, the network entity 502 may perform any of various operations to mitigate or avoid the effects of the disruption. The various operations may allow the UE 504 to communicate with the network entity 502 during the duration of the disruption. The various operations may allow the UE 504 to avoid or refrain from performing a beam failure recovery and/or cell reselection operation.

In some cases, the network entity 502 may send, to the UE 504, an indication to communicate via a different communication link (for example, the second communication link 514) during at least a portion of the duration of the disruption. In certain cases, the network entity 502 may send, to the UE 504, an indication of a modification to one or more parameters for communicating via the first communication link 510 during at least a portion of the duration of the disruption. The modification may be or include a modification to the MCS (e.g., a reduced MCS), MIMO layers (e.g., fewer MIMO layers), frequency resources (e.g., a reduced channel bandwidth, a lower frequency band, etc.), etc. The modification to the parameters may enable communications with reduced signal quality and/or signal strength during the disruption. In some cases, the network entity 502 may send, to the UE 504, an indication to refrain from communicating via the first communication link 510, for example, for the duration of the disruption. This may allow the UE 504 to transition to a low power state during the duration of the disruption and consume less power.

In certain cases, the network entity 502 may wait for the UE 504 to report on the channel conditions encountered during the disruption, for example, as a part of channel state feedback (CSF). If the disruption did not degrade the signal quality of the communication link by a specific level (or any other suitable criteria), the network entity 502 may decide to continue to communicate with the UE 504 via the same communication link.

### Example Operations of Communication Link Disruption Reporting and Mitigation in a Communications System

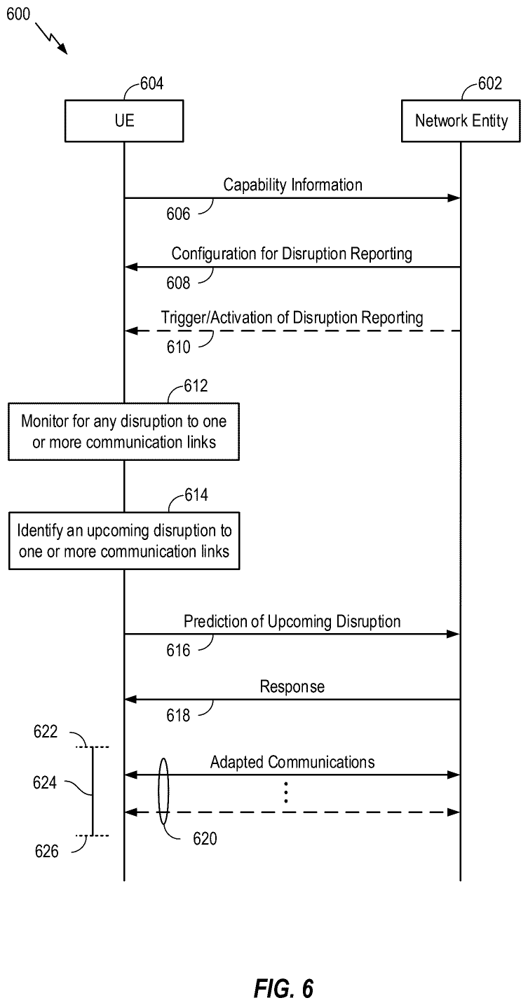

FIG. 6 depicts a process flow 600 for communications in a system between a network entity 602 and a user equipment (UE) 604 involved in reporting an upcoming communication link disruption. In some aspects, the network entity 602 may be an example of the BS 102 depicted and described with respect to FIGS. 1 and 3 or a disaggregated base station depicted and described with respect to FIG. 2. Similarly, the UE 604 may be an example of UE 104 depicted and described with respect to FIGS. 1 and 3. However, in other aspects, UE 604 may be another type of wireless communications device and network entity 602 may be another type of network entity or network node, such as those described herein. Note that any operations illustrated with dashed lines indicates that that operation may be optional or an alternative.

At 606, the UE 604 sends, to the network entity 602, capability information that indicates that the UE 604 is capable of sensing for disruptions to a communication link, for example, as described herein with respect to FIG. 5. The capability information may indicate one or more measurement or sensing capabilities of the UE 504 to sense any disruption and/or any object-based disruption. The capability information may indicate a type of sensing (e.g., active sensing, passive sensing, sensor type, or sensor identifier) available for monitoring for a disruption. The capability information may indicate spatial information associated with sensing capabilities. The spatial information may include a field of view that the sensing is capable of observing, for example, in terms of an azimuth, elevation, horizontal arc, vertical arc, and/or a diagonal arc. The spatial information may include a range (e.g., distance or radius) or space (e.g., a perimeter or volume) that the sensing is capable of observing.

At 608, the UE 604 obtains, from the network entity 602, a configuration indicating one or more parameters associated with monitoring for and/or reporting a disruption to a communication link. The rate of monitoring and/or reporting configured at the UE 604 may depend on various factors including, for example, the system conditions (e.g., channel capacity, disruption reports from other UEs, etc.), UE capability, UE mobility, and/or area conditions (rural, urban, etc.). The network entity 602 may decide that the UE monitor for a disruption in specific orientations or a space near a communication link (e.g., a beam) or other candidate communication link(s). The network entity 602 may consider or take into account the spatial monitoring capabilities of the UE 604. The configuration may be obtained via control signaling including, for example, downlink control information (DCI), sidelink control information (SCI), medium access control (MAC) signaling, RRC signaling, and/or system information.

In certain aspects, the configuration may indicate when and how to monitor for a disruption, for example, in accordance with the capability information. The configuration may indicate a periodicity for monitoring for any disruptions (such as object-based disruptions), the type of sensing to use for monitoring, and/or spatial information for monitoring any disruptions (e.g., the orientation and/or range of monitoring). The configuration may indicate certain criteria or event(s) that trigger monitoring for a disruption, such as establishing a communication link or an RRC connection. The configuration may indicate which communication links to monitor for a disruption. The configuration may indicate when to report a disruption, for example, periodically, semi-persistently, and/or aperiodically.

In certain aspects, the configuration may indicate what information to report with respect to a prediction of an upcoming disruption. The information to report may include when the disruption is expected to start, the duration of the disruption, which communication link(s) are expected to be affected by the disruption, a location of the disruption and/or or UE 604, a mobility state of the UE 604, and a severity of the disruption.

At 610, the UE 604 obtains, from the network entity 602, an indication that triggers a disruption report and/or an activation of semi-persistent reporting of disruption monitoring. The trigger and/or activation may be obtained via control signaling including, for example, DCI, SCI, MAC signaling, RRC signaling, and/or system information.

At 612, the UE 604 monitors for any disruption to one or more communication links, such as the first communication link 510. For example, the UE 604 may perform activing and/or passive scanning for a disruption as described herein with respect to FIG. 5.

At 614, the UE 604 identifies or predicts an upcoming disruption to a communication link may likely occur. For example, the UE 604 may determine that a physical obstruction is traveling on a path that intersects a communication link. In some cases, the UE 604 may determine that it is traveling on a path that will cause the obstruction to intersect a communication link.

At 616, the UE 604 send, to the network entity 602, a report that indicates a prediction of the upcoming disruption to the communication link. For example, the prediction of the upcoming disruption may include an indication of a start time 622 for the upcoming disruption, an indication of a duration 624 for the upcoming disruption, an indication of an end time 626 for the upcoming disruption, and/or an indication of the communication link(s) expected to be affected by the upcoming disruption. The duration 624 may be or include the time period during which the disruption is disrupting or affecting (or predicted or expected to disrupt or affect) a communication link. In some cases, as the duration 624 may be a predicted value, a portion of the duration 624 may be or include a buffer time in order to account for any error associated with the prediction.

At 618, the UE 604 obtains, from the network entity 602, a response to the report. The response may indicate to switch to a different communication link, such as the second communication link 514 of FIG. 5, for communications with the network entity 602 for at least a portion of the duration 624 of the disruption. The response may indicate to refrain from communicating via the disrupted communication link. The response may indicate to modify one or more parameters associated with the communication link, such as the MCS, code rate, channel bandwidth, and/or subcarrier spacing. The modification may allow the UE 604 to communicate with the network entity 602 while encountering the disruption. In certain cases, the response may indicate to report one or more channel properties of the communication link expected to encounter the disruption as observed during the disruption at the UE 604. In some cases, if the UE 604 does not obtain the response to the report, the UE 604 may refrain from communicating with the network entity 602 via the communication link expected to encounter the disruption. The response may be obtained via control signaling including, for example, DCI, SCI, MAC signaling, RRC signaling, and/or system information.

At 620, the UE 604 communicates with the network entity 602 in accordance with the response. As an example, the UE 604 may switch to communicating with the network entity 602 via a different communication link, such as the second communication link 514 of FIG. 5. After the disruption ends, the network entity 602 may signal to the UE 604 to communicate via the previous communication link, such as the first communication link 510 of FIG. 5.

The disruption reporting described above may allow the UE 604 to refrain from performing a beam failure recovery operation and/or a cell reselection operation, which may beneficially conserve channel capacity, power consumption, and avoid the latency associated with such operations. In some cases, the disruption reporting described above may allow the UE 604 to enter a low power state during the disruption, and thus, conserving power consumption.

While the examples depicted in FIGS. 5 and 6 are described herein with respect to monitoring for and reporting disruptions to downlink communications to facilitate understanding, aspects of the present disclosure may also be applied to monitoring for and reporting disruptions to uplink and/or sidelink communications.

### Example Operations of Communication Link Disruption Mitigation

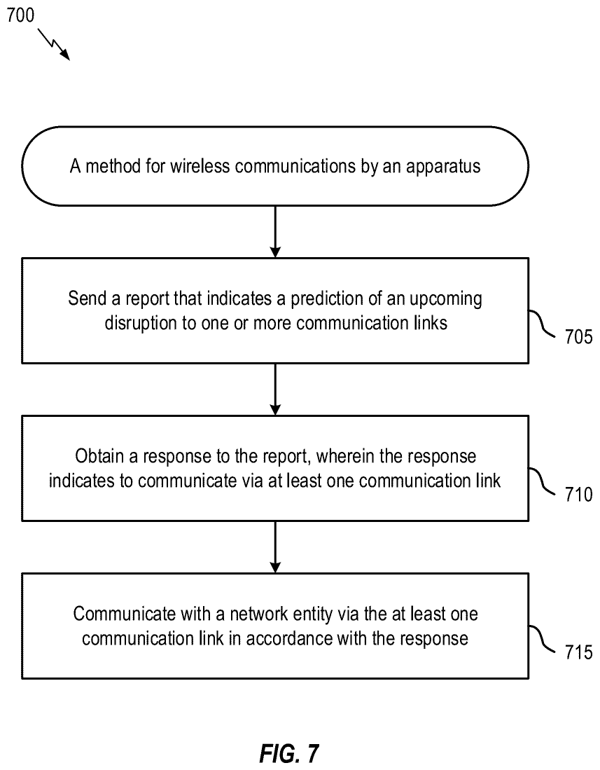

FIG. 7 shows a method 700 for wireless communications by an apparatus, such as UE 104 of FIGS. 1 and 3.

Method 700 begins at block 705 with sending a report that indicates a prediction of an upcoming disruption to one or more communication links. The upcoming disruption may be predicted to occur at a future time period. In certain aspects, the report comprises one or more of: an indication of a start time (e.g., the start time 622 of FIG. 6) for the upcoming disruption, an indication of a duration for the upcoming disruption (e.g., the duration 624 of FIG. 6), an indication of a location of the upcoming disruption, or an indication of the one or more communication links expected to be affected by the upcoming disruption (e.g., a beam identifier, a reference signal identifier, etc.). In certain aspects, the upcoming disruption comprises a physical obstruction (e.g., the object 530 of FIG. 5) expected to disrupt the one or more communication links.

Method 700 then proceeds to block 710 with obtaining a response to the report, where the response indicates to communicate via at least one communication link for example, as described herein with respect to FIGS. 5 and 6. In certain aspects, the response indicates to communicate via the at least one communication link in at least a portion of a duration for the upcoming disruption. In certain aspects, the response indicates to modify one or more parameters associated with the at least one communication link. In certain aspects, the one or more parameters comprises one or more of: a MCS, a code rate, a channel bandwidth, a carrier frequency band, a total number of MIMO layers, or a subcarrier spacing. In certain aspects, the response indicates to switch from the one or more communication links to the at least one communication link. In certain aspects, the response indicates to refrain from communications via the one or more communication links in at least a portion of a duration for the upcoming disruption and/or indicates to communicate via the at least one communication link after the upcoming disruption is expected to end (for example, the end time 626 of FIG. 6).

Method 700 then proceeds to block 715 with communicating with a network entity (e.g., the network entity 502 of FIG. 5) via the at least one communication link in accordance with the response. For example, the apparatus may communicate via a different communication link and/or with modified parameters as indicated or specified in the response. In certain aspects, block 715 includes obtaining, from the network entity, one or more signals via the at least one communication link.

In certain aspects, method 700 further includes sending capability information indicating a capability of the apparatus to sense a disruption to a communication link. In certain aspects, the capability information comprises an indication of one or more measurement capabilities of the apparatus to sense the disruption. The measurement capabilities may be or include a type of sensor or sensing (passive or active) supported at the apparatus. The measurement capabilities may be or include spatial information associated with a sensor or sensing supported at the apparatus, such as a tilt resolution, an azimuth resolution, an elevation resolution, a field of view of the sensor, a range of the sensor, and/or a coverage space of the sensor.

In certain aspects, method 700 further includes obtaining a configuration indicating when to send the report. In certain aspects, the configuration indicates a periodicity for reporting whether any upcoming disruption is predicted. In certain aspects, the configuration further indicates the one or more communication links to monitor for any upcoming disruption. In certain aspects, the configuration further indicates an event that triggers the apparatus to send the report, such as aperiodic DCI and/or a specific triggering event (e.g., channel state, UE mobility state, connection state, etc.). In certain aspects, the configuration indicates to send the report according to periodic reporting, semi-persistent reporting, or aperiodic reporting.

In certain aspects, method 700 further includes monitoring for any disruption to the one or more communication links using one or more sensors (e.g., the sensor 520 of FIG. 5). In certain aspects, method 700 further includes identifying the upcoming disruption based at least in part on one or more measurements of the one or more sensors.

In certain aspects, the one or more communication links comprise one or more beamformed communication links corresponding to one or more beams, for example, as described herein with respect to FIG. 5.

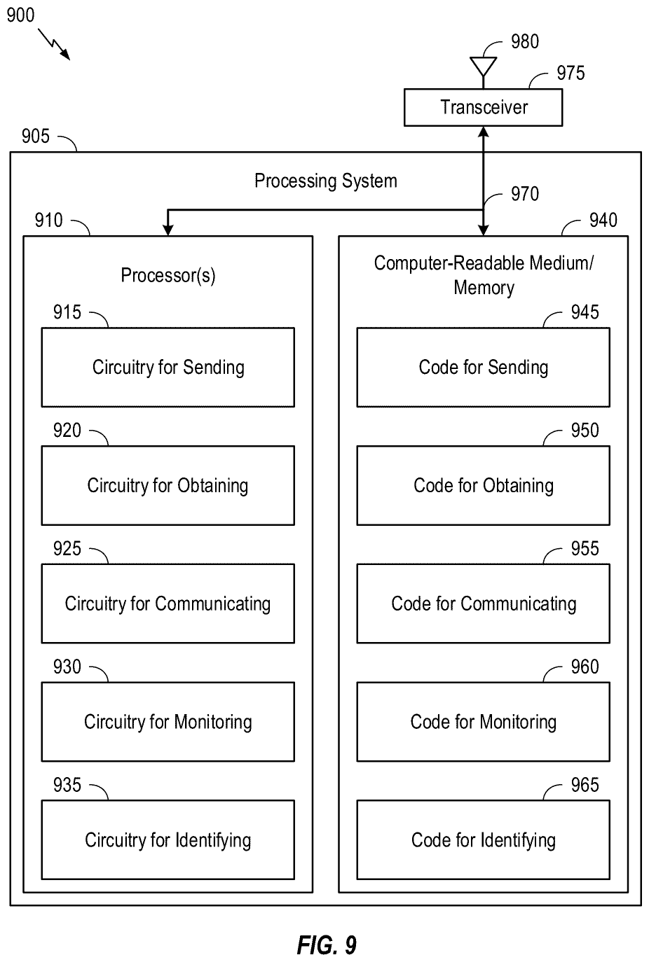

In certain aspects, method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative operations are possible consistent with this disclosure.

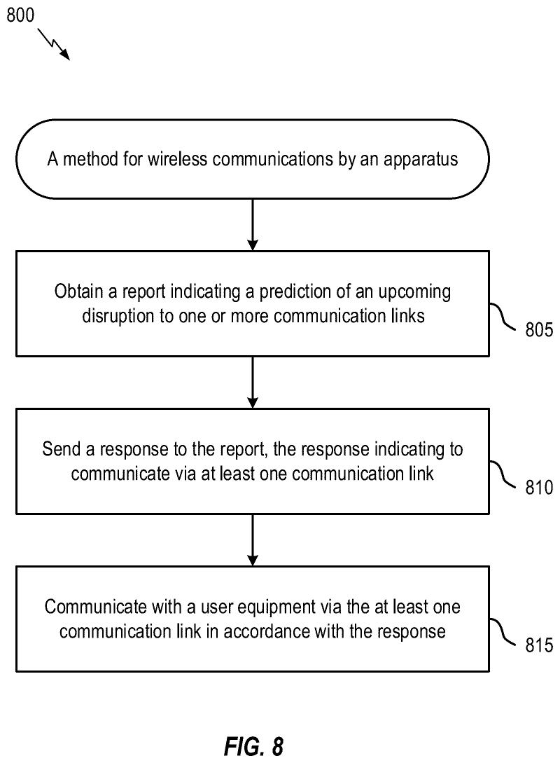

FIG. 8 shows a method 800 for wireless communications by an apparatus, such as BS 102 of FIGS. 1 and 3, or a disaggregated base station as discussed with respect to FIG. 2.

Method 800 begins at block 805 with obtaining a report indicating a prediction of an upcoming disruption to one or more communication links. In certain aspects, the report comprises one or more of: an indication of a start time for the upcoming disruption, an indication of a duration for the upcoming disruption, an indication of a location of the upcoming disruption, or an indication of the one or more communication links expected to be affected by the upcoming disruption. In certain aspects, the upcoming disruption comprises a physical obstruction expected to disrupt the one or more communication links.

Method 800 then proceeds to block 810 with sending a response to the report, where the response indicates to communicate via at least one communication link, for example, as described herein with respect to FIGS. 5 and 6. In certain aspects, the response indicates to communicate via the at least one communication link in at least a portion of a duration for the upcoming disruption. In certain aspects, the response indicates to modify one or more parameters associated with the at least one communication link. In certain aspects, the one or more parameters comprises one or more of: a MCS, a code rate, a channel bandwidth, a carrier frequency band, a total number of MIMO layers, or a subcarrier spacing. In certain aspects, the response indicates to switch from the one or more communication links to the at least one communication link. In certain aspects, the response indicates to refrain from communications via the one or more communication links in at least a portion of a duration for the upcoming disruption and/or indicates to communicate via the at least one communication link after the upcoming disruption is expected to end.

Method 800 then proceeds to block 815 with communicating with a user equipment via the at least one communication link in accordance with the response. For example, the apparatus may communicate via a different communication link and/or with modified parameters as indicated or specified in the response. In certain aspects, block 815 includes sending, to the user equipment, one or more signals via the at least one communication link.

In certain aspects, method 800 further includes obtaining capability information indicating a capability of the user equipment to sense a disruption to a communication link. In certain aspects, the capability information comprises an indication of one or more measurement capabilities of the user equipment to sense the disruption.

In certain aspects, method 800 further includes sending a configuration indicating when to send the report. In certain aspects, the configuration indicates a periodicity for reporting whether any upcoming disruption is predicted. In certain aspects, the configuration further indicates the one or more communication links to monitor for any upcoming disruption. In certain aspects, the configuration further indicates an event that triggers communication of the report. In certain aspects, the configuration indicates to send the report according to periodic reporting, semi-persistent reporting, or aperiodic reporting.

In certain aspects, the one or more communication links comprise one or more beamformed communication links corresponding to one or more beams.

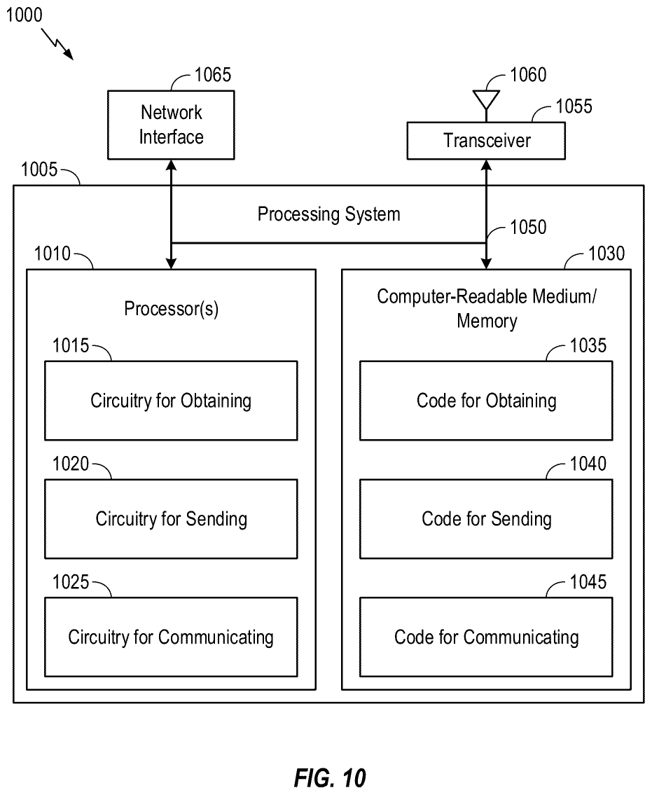

In certain aspects, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative operations are possible consistent with this disclosure.

### Example Communications Devices

FIG. 9 depicts aspects of an example communications device 900. In some aspects, communications device 900 is a user equipment, such as UE 104 described above with respect to FIGS. 1 and 3.

The communications device 900 includes a processing system 905 coupled to a transceiver 975 (e.g., a transmitter and/or a receiver). The transceiver 975 is configured to transmit and receive signals for the communications device 900 via an antenna 980, such as the various signals as described herein. The processing system 905 may be configured to perform processing functions for the communications device 900, including processing signals received and/or to be transmitted by the communications device 900.

The processing system 905 includes one or more processors 910. In various aspects, the one or more processors 910 may be representative of one or more of receive processor 358, transmit processor 364, TX MIMO processor 366, and/or controller/processor 380, as described with respect to FIG. 3. The one or more processors 910 are coupled to a computer-readable medium/memory 940 via a bus 970. In certain aspects, the computer-readable medium/memory 940 is configured to store instructions (e.g., computer-executable code) that when executed by the one or more processors 910, enable and cause the one or more processors 910 to perform the method 700 described with respect to FIG. 7, or any aspect related to it, including any operations described in relation to FIG. 7. Note that reference to a processor performing a function of communications device 900 may include one or more processors performing that function of communications device 900, such as in a distributed fashion.

In the depicted example, computer-readable medium/memory 940 stores code for sending 945, code for obtaining 950, code for communicating 955, code for monitoring 960, and code for identifying 965. Processing of the code 945-965 may enable and cause the communications device 900 to perform the method 700 described with respect to FIG. 7, or any aspect related to it.

The one or more processors 910 include circuitry configured to implement (e.g., execute) the code stored in the computer-readable medium/memory 940, including circuitry for sending 915, circuitry for obtaining 920, circuitry for communicating 925, circuitry for monitoring 930, and circuitry for identifying 935. Processing with circuitry 915-935 may enable and cause the communications device 900 to perform the method 700 described with respect to FIG. 7, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 975 and/or antenna 980 of the communications device 900 in FIG. 9, and/or one or more processors 910 of the communications device 900 in FIG. 9. Means for communicating, receiving or obtaining may include the transceivers 354, antenna(s) 352, receive processor 358, AI processor 370, and/or controller/processor 380 of the UE 104 illustrated in FIG. 3, transceiver 975 and/or antenna 980 of the communications device 900 in FIG. 9, and/or one or more processors 910 of the communications device 900 in FIG. 9. Means for monitoring and/or identifying may include the AI processor 370, and/or controller/processor 380 of the UE 104 illustrated in FIG. 3, and/or one or more processors 910 of the communications device 900 in FIG. 9.

FIG. 10 depicts aspects of an example communications device 1000. In some aspects, communications device 1000 is a network entity, such as BS 102 of FIGS. 1 and 3, or a disaggregated base station as discussed with respect to FIG. 2.

The communications device 1000 includes a processing system 1005 coupled to a transceiver 1055 (e.g., a transmitter and/or a receiver) and/or a network interface 1065. The transceiver 1055 is configured to transmit and receive signals for the communications device 1000 via an antenna 1060, such as the various signals as described herein. The network interface 1065 is configured to obtain and send signals for the communications device 1000 via communications link(s), such as a backhaul link, midhaul link, and/or fronthaul link as described herein, such as with respect to FIG. 2. The processing system 1005 may be configured to perform processing functions for the communications device 1000, including processing signals received and/or to be transmitted by the communications device 1000.

The processing system 1005 includes one or more processors 1010. In various aspects, one or more processors 1010 may be representative of one or more of receive processor 338, transmit processor 320, TX MIMO processor 330, and/or controller/processor 340, as described with respect to FIG. 3. The one or more processors 1010 are coupled to a computer-readable medium/memory 1030 via a bus 1050. In certain aspects, the computer-readable medium/memory 1030 is configured to store instructions (e.g., computer-executable code) that when executed by the one or more processors 1010, enable and cause the one or more processors 1010 to perform the method 800 described with respect to FIG. 8, or any aspect related to it, including any operations described in relation to FIG. 8. Note that reference to a processor of communications device 1000 performing a function may include one or more processors of communications device 1000 performing that function, such as in a distributed fashion.

In the depicted example, the computer-readable medium/memory 1030 stores code for obtaining 1035, code for sending 1040, and code for communicating 1045. Processing of the code 1035-1045 may enable and cause the communications device 1000 to perform the method 800 described with respect to FIG. 8, or any aspect related to it.

The one or more processors 1010 include circuitry configured to implement (e.g., execute) the code stored in the computer-readable medium/memory 1030, including circuitry for obtaining 1015, circuitry for sending 1020, and circuitry for communicating 1025. Processing with circuitry 1015-1025 may enable and cause the communications device 1000 to perform the method 800 described with respect to FIG. 8, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1055, antenna 1060, and/or network interface 1065 of the communications device 1000 in FIG. 10, and/or one or more processors 1010 of the communications device 1000 in FIG. 10. Means for communicating, receiving or obtaining may include the transceivers 332, antenna(s) 334, receive processor 338, AI processor 318, and/or controller/processor 340 of the BS 102 illustrated in FIG. 3, transceiver 1055, antenna 1060, and/or network interface 1065 of the communications device 1000 in FIG. 10, and/or one or more processors 1010 of the communications device 1000 in FIG. 10.

### Example Clauses

Implementation examples are described in the following numbered clauses:

Clause 1: A method for wireless communications by an apparatus comprising: sending a report that indicates a prediction of an upcoming disruption to one or more communication links; obtaining a response to the report, wherein the response indicates to communicate via at least one communication link; and communicating with a network entity via the at least one communication link in accordance with the response.

Clause 2: The method of Clause 1, wherein the report comprises one or more of: an indication of a start time for the upcoming disruption, an indication of a duration for the upcoming disruption, an indication of a location of the upcoming disruption, or an indication of the one or more communication links expected to be affected by the upcoming disruption.

Clause 3: The method of any one of Clauses 1-2, wherein the upcoming disruption comprises a physical obstruction expected to disrupt the one or more communication links.

Clause 4: The method of any one of Clauses 1-3, wherein the response indicates to communicate via the at least one communication link in at least a portion of a duration for the upcoming disruption.

Clause 5: The method of any one of Clauses 1-4, wherein the response indicates to modify one or more parameters associated with the at least one communication link.

Clause 6: The method of Clause 5, wherein the one or more parameters

comprises one or more of: a MCS, a code rate, a channel bandwidth, or a subcarrier spacing.

Clause 7: The method of any one of Clauses 1-6, wherein the response indicates to switch from the one or more communication links to the at least one communication link.

Clause 8: The method of any one of Clauses 1-7, wherein the response indicates to refrain from communications via the one or more communication links in at least a portion of a duration for the upcoming disruption and indicates to communicate via the at least one communication link after the upcoming disruption is expected to end.

Clause 9: The method of any one of Clauses 1-8, further comprising sending capability information indicating a capability of the apparatus to sense a disruption to a communication link.

Clause 10: The method of Clause 9, wherein the capability information comprises an indication of one or more measurement capabilities of the apparatus to sense the disruption.

Clause 11: The method of any one of Clauses 1-10, further comprising obtaining a configuration indicating when to send the report.

Clause 12: The method of Clause 11, wherein the configuration indicates a periodicity for reporting whether any upcoming disruption is predicted.

Clause 13: The method of Clause 11 or 12, wherein the configuration further indicates the one or more communication links to monitor for any upcoming disruption.

Clause 14: The method of any one of Clauses 11-13, wherein the configuration further indicates an event that triggers the apparatus to send the report.

Clause 15: The method of any one of Clauses 11-14, wherein the configuration indicates to send the report according to periodic reporting, semi-persistent reporting, or aperiodic reporting.

Clause 16: The method of any one of Clauses 1-15, further comprising: monitoring for any disruption to the one or more communication links using one or more sensors; and identifying the upcoming disruption based at least in part on one or more measurements of the one or more sensors.

Clause 17: The method of any one of Clauses 1-16, wherein the one or more communication links comprise one or more beamformed communication links corresponding to one or more beams.

Clause 18: The method of any one of Clauses 1-17, wherein communicating with the network entity via the at least one communication link comprises obtaining, from the network entity, one or more signals via the at least one communication link.

Clause 19: A method for wireless communications by an apparatus comprising: obtaining a report indicating a prediction of an upcoming disruption to one or more communication links; sending a response to the report, wherein the response indicates to communicate via at least one communication link; and communicating with a user equipment via the at least one communication link in accordance with the response.

Clause 20: The method of Clause 19, wherein the report comprises one or more of: an indication of a start time for the upcoming disruption, an indication of a duration for the upcoming disruption, an indication of a location of the upcoming disruption, or an indication of the one or more communication links expected to be affected by the upcoming disruption.

Clause 21: The method of any one of Clauses 19-20, wherein the upcoming disruption comprises a physical obstruction expected to disrupt the one or more communication links.

Clause 22: The method of any one of Clauses 19-21, wherein the response indicates to communicate via the at least one communication link in at least a portion of a duration for the upcoming disruption.

Clause 23: The method of any one of Clauses 19-22, wherein the response indicates to modify one or more parameters associated with the at least one communication link.

Clause 24: The method of Clause 23, wherein the one or more parameters comprises one or more of: a MCS, a code rate, a channel bandwidth, or a subcarrier spacing.

Clause 25: The method of any one of Clauses 19-24, wherein the response indicates to switch from the one or more communication links to the at least one communication link.

Clause 26: The method of any one of Clauses 19-25, wherein the response indicates to refrain from communications via the one or more communication links in at least a portion of a duration for the upcoming disruption and indicates to communicate via the at least one communication link after the upcoming disruption is expected to end.

Clause 27: The method of any one of Clauses 19-26, further comprising obtaining capability information indicating a capability of the user equipment to sense a disruption to a communication link.

Clause 28: The method of Clause 27, wherein the capability information comprises an indication of one or more measurement capabilities of the user equipment to sense the disruption.

Clause 29: The method of any one of Clauses 19-28, further comprising sending a configuration indicating when to send the report.

Clause 30: The method of Clause 29, wherein the configuration indicates a periodicity for reporting whether any upcoming disruption is predicted.

Clause 31: The method of Clause 29 or 30, wherein the configuration further indicates the one or more communication links to monitor for any upcoming disruption.

Clause 32: The method of any one of Clauses 29-31, wherein the configuration further indicates an event that triggers communication of the report.

Clause 33: The method of any one of Clauses 29-32, wherein the configuration indicates to send the report according to periodic reporting, semi-persistent reporting, or aperiodic reporting.

Clause 34: The method of any one of Clauses 19-33, wherein the one or more communication links comprise one or more beamformed communication links corresponding to one or more beams.

Clause 35: The method of any one of Clauses 19-34, wherein communicating with the user equipment via the at least one communication link comprises sending, to the user equipment, one or more signals via the at least one communication link.

Clause 36: One or more apparatuses, comprising: one or more memories comprising executable instructions; and one or more processors configured to execute the executable instructions and cause the one or more apparatuses to perform a method in accordance with any one of Clauses 1-35.

Clause 37: One or more apparatuses, comprising: one or more memories; and one or more processors, coupled to the one or more memories, configured to cause the one or more apparatuses to perform a method in accordance with any one of Clauses 1-35.

Clause 38: One or more apparatuses, comprising: one or more memories; and one or more processors, coupled to the one or more memories, configured to perform a method in accordance with any one of Clauses 1-35.

Clause 39: One or more apparatuses, comprising means for performing a method in accordance with any one of Clauses 1-35.

Clause 40: One or more non-transitory computer-readable media comprising executable instructions that, when executed by one or more processors of one or more apparatuses, cause the one or more apparatuses to perform a method in accordance with any one of Clauses 1-35.

Clause 41: One or more computer program products embodied on one or more computer-readable storage media comprising code for performing a method in accordance with any one of Clauses 1-35.

Clause 42: A user equipment (UE), comprising: a processing system that includes processor circuitry and memory circuitry that stores code and is coupled with the processor circuitry, the processing system configured to cause the UE to perform a method in accordance with any one of Clauses 1-35.

Clause 43: A network entity, comprising: a processing system that includes processor circuitry and memory circuitry that stores code and is coupled with the processor circuitry, the processing system configured to cause the network entity to perform a method in accordance with any one of Clauses 1-35.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
send a report that indicates a prediction of an upcoming disruption to one or more communication links;
obtain a response to the report, wherein the response indicates to communicate via at least one communication link; and
communicate with a network entity via the at least one communication link in accordance with the response.

2. The apparatus of claim 1, wherein the report comprises one or more of:
an indication of a start time for the upcoming disruption,
an indication of a duration for the upcoming disruption, or
an indication of the one or more communication links expected to be affected by the upcoming disruption.

3. The apparatus of claim 1, wherein the upcoming disruption comprises a physical obstruction expected to disrupt the one or more communication links.

4. The apparatus of claim 1, wherein the response indicates to communicate via the at least one communication link in at least a portion of a duration for the upcoming disruption.

5. The apparatus of claim 1, wherein the response indicates to modify one or more parameters associated with the at least one communication link.

6. The apparatus of claim 1, wherein the response indicates to switch from the one or more communication links to the at least one communication link.

7. The apparatus of claim 1, wherein the response indicates to refrain from communications via the one or more communication links in at least a portion of a duration for the upcoming disruption and indicates to communicate via the at least one communication link after the upcoming disruption is expected to end.

8. The apparatus of claim 1, wherein the one or more processors are configured to cause the apparatus to send capability information indicating a capability of the apparatus to sense a disruption to a communication link.

9. The apparatus of claim 8, wherein the capability information comprises an indication of one or more measurement capabilities of the apparatus to sense the disruption.

10. The apparatus of claim 1, wherein the one or more processors are configured to cause the apparatus to obtain a configuration indicating when to send the report.

11. The apparatus of claim 1, wherein the one or more processors are configured to cause the apparatus to:
monitor for any disruption to the one or more communication links using one or more sensors; and
identify the upcoming disruption based at least in part on one or more measurements of the one or more sensors.

12. The apparatus of claim 1, wherein the one or more communication links comprise one or more beamformed communication links corresponding to one or more beams.

13. An apparatus configured for wireless communications, comprising:
one or more memories; and
one or more processors coupled to the one or more memories, the one or more processors being configured to cause the apparatus to:
obtain a report indicating a prediction of an upcoming disruption to one or more communication links;
send a response to the report, wherein the response indicates to communicate via at least one communication link; and
communicate with a user equipment via the at least one communication link in accordance with the response.

14. The apparatus of claim 13, wherein the report comprises one or more of:
an indication of a start time for the upcoming disruption,
an indication of a duration for the upcoming disruption, or
an indication of the one or more communication links expected to be affected by the upcoming disruption.

15. The apparatus of claim 13, wherein:
the upcoming disruption comprises a physical obstruction expected to disrupt the one or more communication links;
the one or more communication links comprise one or more beamformed communication links corresponding to one or more beams; and
the response indicates to communicate via the at least one communication link in at least a portion of a duration for the upcoming disruption.

16. The apparatus of claim 13, wherein the response indicates to modify one or more parameters associated with the at least one communication link.

17. The apparatus of claim 13, wherein the response indicates to switch from the one or more communication links to the at least one communication link.

18. The apparatus of claim 13, wherein the one or more processors are configured to cause the apparatus to obtain capability information indicating a capability of the user equipment to sense a disruption to a communication link.

19. The apparatus of claim 13, wherein the one or more processors are configured to cause the apparatus to send a configuration indicating when to send the report.

20. A method for wireless communications by an apparatus, comprising:
sending a report that indicates a prediction of an upcoming disruption to one or more communication links;
obtaining a response to the report, wherein the response indicates to communicate via at least one communication link; and
communicating with a network entity via the at least one communication link in accordance with the response.
